(19) United States
(12) Patent Application Publication
(10) Pub. No.: US 2016/0155054 A1
(43) Pub. Date: Jun. 2, 2016

(54) Method of Operating a Solution Searching System and Solution Searching System

(71) Applicants: Inventec (Pudong) Technology Corp., Shanghai (CN); Inventec Corporation, Taipei (TW)

(72) Inventor: Ying-Chih Lu, Taipei (TW)

(21) Appl. No.: 14/662,197

(22) Filed: Mar. 18, 2015

(30) Foreign Application Priority Data
Nov. 27, 2014 (CN) 201410707231.6

(51) Int. Cl. G06N 5/04; G06N 99/00; G06F 17/30

(52) U.S. Cl. CPC G06N 5/04; G06F 17/30663; G06N 99/005

(57) ABSTRACT

A solution searching system includes a utility server, N model running servers, a database server, and a central controller server. The utility server is configured to generate N first model input files according to a first issue description file. Each model running server is configured to generate a first solution key according to a corresponding first model input file and a corresponding prediction model. The database server is configured to read a first solution file from a database according to the first solution key. The central controller server is configured to transfer the first issue description file to the utility server, to transfer the first model input files to the model running servers, to transfer the first solution keys to the database server, and to output the first solution file according to a weight value of each of the model running servers.

### BACKGROUND OF THE INVENTION

1. Field of the Invention

The present invention relates to a solution searching system, and more particularly, to a solution searching system using techniques of big data and data mining.

2. Description of the Prior Art

The success of a product may not only require technical research and design, but also great efforts of testing for ensuring the stability of the product, especially for high-tech products that require high stability and high reliability, such as industrial instruments, mobile devices, work stations, personal computers or servers, the standard for quality test is even stricter. When the products examined have issues, it may be needed to reproduce the issues, collect and analyze the related information, find out the root causes, propose solutions and to test the proposed solutions before one can actually confirm that the examined issues are solved. These processes can be time consuming and may cause the products late to market. Also, the processes may be dependent on the engineer's profession and experience. Namely, the degree of the engineer's profession and experience can largely affect the time required for the issue to be solved and also affect the quality of the solution. Therefore, the quality of the solutions is difficult to control. In addition, since it can be difficult to extend one's personal experience to another, it may require different engineers doing the same above processes to solve the same or similar issues, which can be very inefficient and cannot ensure that the engineer will find out the best solution all the time.

Moreover, for products of the same types, the possibility to find the same or similar issues can be rather high. Although the solutions may also be recorded or stored in some prior arts, it is still difficult to store the information systematically for the great variety of different issues, the great amounts of data, and the different ways of the engineers to describe the issues. Therefore, the engineers still have difficulty finding the related solutions in practical, and the goal to share the engineer's experience still has way to go. How to let the engineers share their experiences with each other, find the possible solutions easily and improve the quality of solutions have become a critical issue.

### SUMMARY OF THE INVENTION

One embodiment of the present invention discloses a solution searching system. The solution searching system comprises a utility server, N model running servers, a database, a database server, and a central controller server. The utility server is configured to generate N first model input files corresponding to N prediction models respectively according to a first issue description file, wherein N is an integer greater than 1. Each of the model running servers is corresponding to a weighting and a prediction model of the N prediction models. Each of the model running servers is configured to generate a first solution key according to the prediction model corresponded to the model running server and a first model input file corresponded to the prediction model. The database server is configured to read at least one first solution file from the database according to the first solution keys generated by the N model running servers. The central controller server is configured to transfer the first issue description file to the utility server when receiving the first issue description file, transfer the N first model input files generated by the utility server to the N model running servers, transfer the first solution key generated by each of the model running servers to the database server, and output the at least one first solution file read by the database server from the database according to the weighting of each of the model running servers.

Another embodiment of the present invention discloses a method of operating a solution searching system. The solution searching system comprises a utility server, N model running servers, a database, a database server and a central controller server. The method comprising the central controller server transferring a first issue description file to the utility server when receiving the first issue description file, the utility server generating N first model input files corresponding to N prediction models respectively according to the first issue description file, the central controller server transferring the N first model input files generated by the utility server to the N model running servers, each of the N model running servers generating a first solution key according to a prediction model corresponded to the model running server and a first model input file corresponded to the prediction model, the central controller server transferring the first solution key generated by each of the model running servers to the database server, the database server reading at least one first solution file from the database according to the first solution keys generated by the N model running servers, and the central controller server outputting the at least one first solution file read by the database server from the database according to a weighting of each of the model running servers. Wherein N is an integer greater than 1.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a solution searching system according to one embodiment of the present invention.

FIG. 2 shows a solution searching system according to another embodiment of the present invention.

FIG. 3 shows a method of operating a solution searching system according to one embodiment of the present invention.

FIG. 4 shows a method of operating a solution searching system according to another embodiment of the present invention.

### DETAILED DESCRIPTION

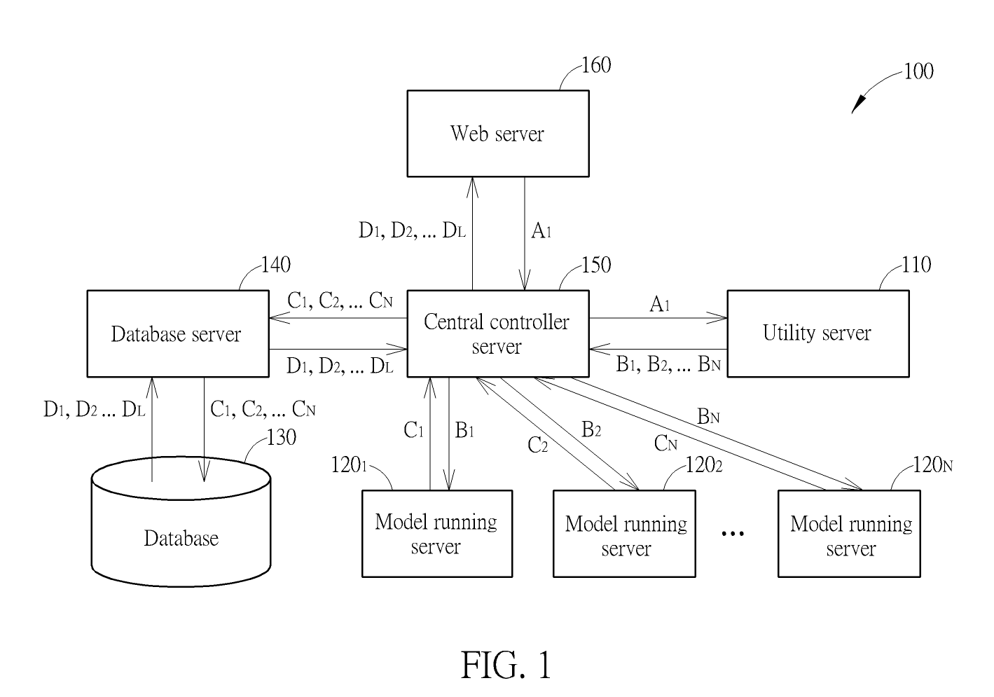

FIG. 1 shows a solution searching system 100 according to one embodiment of the present invention. The solution searching system 100 includes a utility server 110, N model running servers 120₁-120_{N}, a database 130, a database server 140 and a central controller server 150, where N is an integer greater than 1. The utility server 110 can be configured to generate N first model input files B₁-B_{N} corresponding to N prediction models E₁-E_{N} respectively according to a first issue description file A₁. The first issue description file A₁ can be used to describe the information about the system issue of the product with words. The information may include the description of the system issue and phenomenon, sub system which the system issue belongs to, and the situation in which the issue is observed, namely how to reproduce the issue, but not limited to the information aforesaid.

Each of model running server 120ₙ is corresponding to a weighting and a prediction model Eₙ of the N prediction models, where n is a positive integer no greater than N. The model running server 120ₙ can be configured to generate a first solution key Cₙ according to the prediction model Eₙ corresponded to the model running server 120ₙ and a first model input file Bₙ corresponded to the prediction model Eₙ. The database server 140 can be configured to read the first solution files D₁-D_{L} from the database 130 according to the first solution keys C₁-C_{N} generated by the N model running servers 120₁-120_{N}, where Lisa positive integer no greater than N. The central controller server 150 can be configured to transfer the first issue description file A₁ to the utility server 110 when receiving the first issue description file A₁, transfer the N first model input files B₁-B_{N} generated by the utility server 110 to the N model running servers 120₁-120_{N}, transfer the first solution keys C₁-C_{N} generated respectively by the model running servers 120₁-120_{N} to the database server 140, and output the first solution files D₁-D_{L} read by the database server 140 from the database 130 according to the weighting of each of the model running servers 120₁-120_{N}.

In one embodiment of the present invention, the utility server 110 can generate an attribute description file according to the first issue description file A₁, and generate m predictor files according to the attribute description file, where m is a positive integer no greater than N. The utility server 110 can pick up different sets of attributes from the attribute file as predictors to generate different predictor files. In addition, since the prediction model E₁-E_{N} can be generated according to different data mining algorithms and the different data mining algorithms may have different requirements for the formats of input files, the utility server 110 can also adjust the format of the predictor files according to the requirements of the prediction model E₁-E_{N}. For example, the numbers in the predictor file can be removed to generate the first model input file. However, this is not to limit the present invention. The different prediction models may have other kinds of requirements.

In one embodiment of the present invention, the prediction model E₁-E_{N} can be generated according to k different data mining algorithms, such as data mining algorithms of Bayes, CBayes, SGD, and etc., where k is a positive integer no greater than N. Each of the first model input files B₁-B_{N} is corresponding to a predictor file of the m predictor files and a data mining algorithm of the k data mining algorithms. Also, the same data mining algorithms paring to the different predictor files or the same predictor file paring to the different data mining algorithms can all correspond to different prediction models. Therefore, every two first model input files of the first model input files B₁-B_{N} have different combinations of the predictor file and the data mining algorithm. For example, if m equals to 3 and k equals to 2, then there will be at most six different of prediction models. However, this is not to limit the present invention.

In one embodiment of the present invention, the database server 140 and the database 130 can be servers and databases supporting systems of Hadoop Distribute File System (HDFS), Hadoop Map/Reduce, Hive or other database systems that are suitable for managing big data so the requirements of the solution searching system 100 for processing or storing big amounts of data rapidly can be achieved. The solution searching system 100 can also include a relational database or a general file system. The relational database, such as MySql or PostgreSql, is based on general file system for the central controller server 150 to store temporary and small amounts of data.

Furthermore, the solution searching system 100 can further include web server 160. The web server 160 can provide a web page interface for the user to input the first issue description file A₁. After receiving the first issue description file A₁, the web server 160 can transfer the first issue description file A₁ to the central controller server 150, and display the first solution files D₁-D_{L} outputted by the central controller server 150 on the web page interface.

In one embodiment of the present invention, when a correct solution file D₁ of the first solution files D₁-D_{L} is selected by the user, the central controller server 150 can be configured to adjust the weighting of those model running servers of the N model running servers 120₁-120_{N} that generates the same first solution key Cₙ as a solution key corresponding to the correct solution file D₁, where 1 is a positive integer no greater than L. For example, when the first solutions keys C₁-C₂ and C_{N} generated by the model running servers 120₁-120₂ and 120_{N} can all correspond to the correct solution file D₁, the central controller server 150 can increase the weighting of the model running server 120₁-120₂ and 120_{N}. Consequently, the next time when the central controller server 150 output the solution files, the solution files generated by the model running server 120₁-120₂ and 120_{N} may be outputted with higher priorities so that the users can choose the possible solution files more efficiently.

According to the embodiments of the present invention, the solution searching system 100 can help the engineers to share their experiences on how they solve the system issues before, search the possible solutions easily to save time, and can also improve the quality of the solutions.

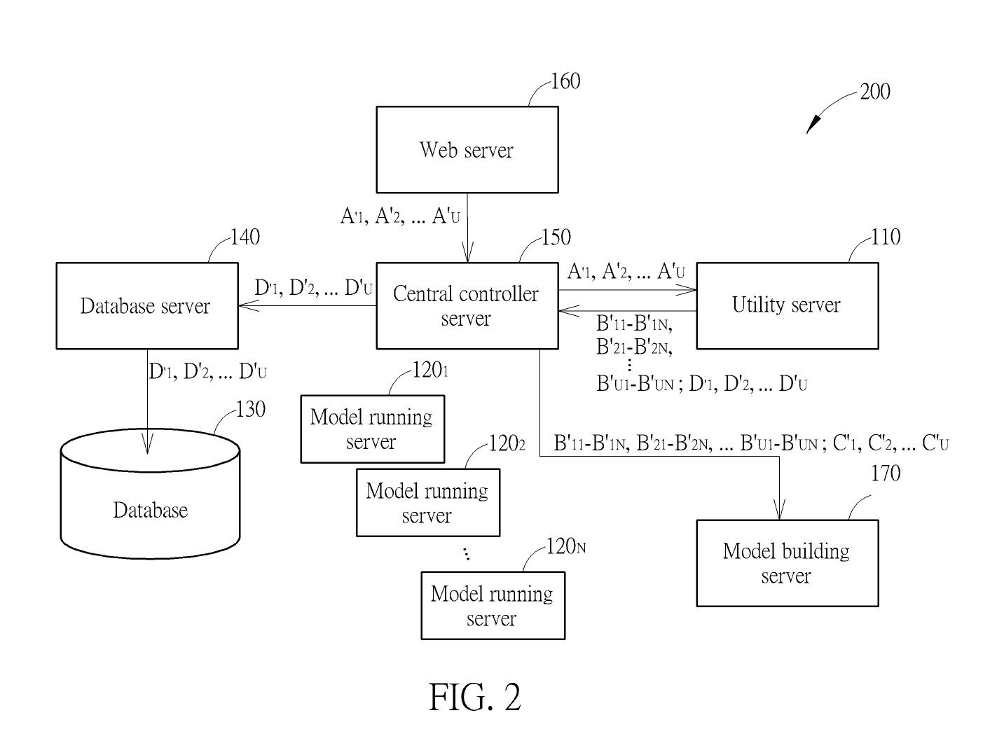

In the embodiment in FIG. 1, the prediction models E₁-E_{N} used by the model running server 120₁-120_{N} can be stored in the system in advance, however, in another embodiment of the present invention, the solution searching system can also be configured to build the prediction model. FIG. 2 shows a solution searching system 200 according to one embodiment of the present invention. The solution searching system 200 can follow the same principles of operations of the solution searching system 100. However, the solution searching system 200 further includes a model building server 170. When central controller server 150 of the solution searching system 200 receives a plurality of solved second issue description files A′₁-A′_{U}, the central controller server 150 can transfer the plurality of solved second issue descriptions files A′₁-A′_{U} to the utility server 110. Each of the plurality of solved second issue description files A′₁-A′_{U} can have the same format as the first issue description file A₁. In addition to columns for recording the information about the system issue, such as the description of the system issue and phenomenon, the sub system which the system issue belongs to, and the situation in which the issue is observed, each of the plurality of solved second issue description files A′₁-A′_{U} may further include a column of the root cause of the system issue, a column of solution instruction and a column of the solution key.

After the utility server 110 receives the plurality of solved second issue description files A′₁-A′_{U}, the utility server 110 can generate a second solution file D′₁, D′₂ . . . or D′_{U} for each of the plurality of solved second issue description files A′₁-A′_{U} and N second model input files B′_{1,1}-B′_{1,N}, B′_{2,1}-B′_{2,N} . . . , B′_{U,1}-B′_{U,N} for each of the plurality of the solved second issue description files A′₁-A′_{U} corresponding to the N prediction models according to the plurality of solved second issue description files A′₁-A′_{U}, where B′_{1,N} represents the second model input file generated according to the second issue description file A′₁ and corresponding to the prediction model E_{N}, and so on. The central controller server 150 can transfer the second solution files D′₁-D′_{U} of each of the plurality of solved second issue description files A′₁-A′_{U} to the database server 140. The database server 140 can store each of the second solution files D′₁-D′_{U} to the database 130 according to the second solution key C′₁-C′_{U} of each of the second solution files D′₁-D′_{U}. Meanwhile, the central controller server 150 can transfer the N second model input files B′_{1,1}-B′_{1,N}, B′_{2,1}-B′_{2,N} . . . , B′_{U,1}-B′_{U,N} and the second solution key C′₁-C′_{U} of each of the plurality of the solved second issue description files A′₁-A′_{U} to the model building server 170. The model building server 170 can build the prediction models according to the second solution keys C′₁-C′_{U} and the N second model input files B′_{1,1}-B′_{1,N}, B′_{2,1}-B′_{2,N} . . . , B′_{U,1}-B′_{U,N} corresponding to each of the plurality of the solved second issue description files A′₁-A′_{U}, and k data mining algorithms. The second solution keys C′₁-C′_{U} can be different from or same as each other.

In one embodiment of the present invention, the utility server 110 can generate the second solution files D′₁-D′_{U} corresponding to each of the second issue description files A′₁-A′_{U} according to the words in each of the second issue description files A′₁-A′_{U}, such as the column for recording the sub system which the system issue belongs to, the column of root cause of the system issue and the column of solution instruction. Although each of the second issue description files A′₁-A′_{U} may already include a corresponding solution key, the utility server 110 can further adjust the solution key of the each of the second issue description files A′₁-A′_{U} according to the information stored in other columns of each of the second issue description files A′₁-A′_{U}. For example, in one embodiment of the present invention, a solution key of a second issue description file may include several sub keys, such as bios.mrc, where sub key “bios” represents that the second issue description file is related to the basic input/output system (BIOS), and the sub key “mrc” represents that the second issue description file is related to memory reference code (MRC) in the basic input/output system. The utility server 110 can expand the solution key “bios.mrc” of the second issue description file to “bios.mrc.i2c” to show that the second issue description file is related to the Inter-integrated circuit (I2C) of the memory reference code of the basic input/output system according to the information stored in other columns. Namely, when a number of sub key of a solution key is greater, the issue is categorized into more detail categories. Since the number of sub keys included in a solution key may affect the speed and accuracy of the solution searching system 200, the number of sub keys can be adjusted according to the system needs.

Furthermore, after the prediction models E₁-E_{N} are built, the solution searching system 200 can test the prediction models E₁-E_{N} according to a plurality of test issue description files and adjust the weighting of each of the model running servers 120₁-120_{N} according to the testing result. In one embodiment of the present invention, each of the test issue description files can have the same format as the first issue description file A₁, and can include information about the system issue, such as columns for recording the description of the system issue and phenomenon, the sub system which the system issue belongs to, and the situation in which the issue is observed. Since the testing issue description files are used to test the prediction models E₁-E_{N}, each of the testing issue description files may describe the different issues from the issues described by the second issue description files A′₁-A′_{U}. Also, each of the testing issue description files may not include the column of the root cause of the system issue, the column of solution instruction and the column of the solution key as the second issue description files A′₁-A′_{U} have. When receiving the plurality of test issue description files, the central controller server 150 can transfer the plurality of test issue description files to the utility server 110, and then, the central controller server 150 can transfer N testing model input files corresponding to each of the test issue description files generated by the utility server 110 to the N model running servers 120₁-120_{N}. The central controller server 150 can further transfer the test solution key corresponding to each of the test issue description files generated by each of the model running servers 120₁-120_{N} to the database server 140. Finally, the central controller server 150 can set an initial value of the weighting for each of the model running servers 120₁-120_{N} according to whether the test solution key generated by each of the model running servers is correct or not. For example, when the solutions keys generated by the model running servers 120₁-120₂ and 120_{N} can correspond to the correct solution file, the central controller server 150 can increase the weighting of the model running server 120₁-120₂ and 120_{N}.

When receiving the first issue prediction file, the solution searching system 200 can store the first issue prediction file in the database 130 and output the solution file as a response to the user. The user can judge whether the solution file of the first issue prediction file is correct or not, namely, the user can confirm if the solution file can actually solve the issue, and the records can also be stored in the database 130. When receiving a predetermined number of the first issue description files, the solution searching system 200 can make the model building server 170 rebuild the N prediction models E₁-E_{N} to maintain the accuracy of the solution prediction of the prediction models E₁-E_{N}. For example, the solution searching system 200 can make the model building server 170 rebuild the N prediction models E₁-E_{N} and refresh the initial value of the weighting of each of the model running server 120₁-120_{N} according to the solution files stored in the database 130, including the plurality of solved second issue description files A′₁-A′_{U} and the predetermined number of the first issue description files that have been solved, with the aforesaid process of generating the prediction models E₁-E_{N} according to the second issue description files.

In one embodiment of the present invention, in the solution searching system 200, the central controller server 150 can transfer data with the utility server 110, the database server 140, the model running servers 120₁-120_{N} and the model building server 170 by network packets and application programming interfaces (APIs) of the central controller server 150, the utility server 110, the database server 140, the model running servers 120₁-120_{N} and the model building server 170. In one embodiment of the present invention, the remote procedure call (PRC) between the APIs can be achieved by adopting the User Datagram Protocol (UDP) or Transmission Control Protocol (TCP) so that the solution searching system 200 can be constructed in a distributed manner, which is easier for system expansion and maintenance.

According to the embodiments of the present invention, the solution searching system 200 can help the engineers to share their experiences on how they solve the system issues before, search the possible solutions easily to save time, and can also improve the quality of the solutions.

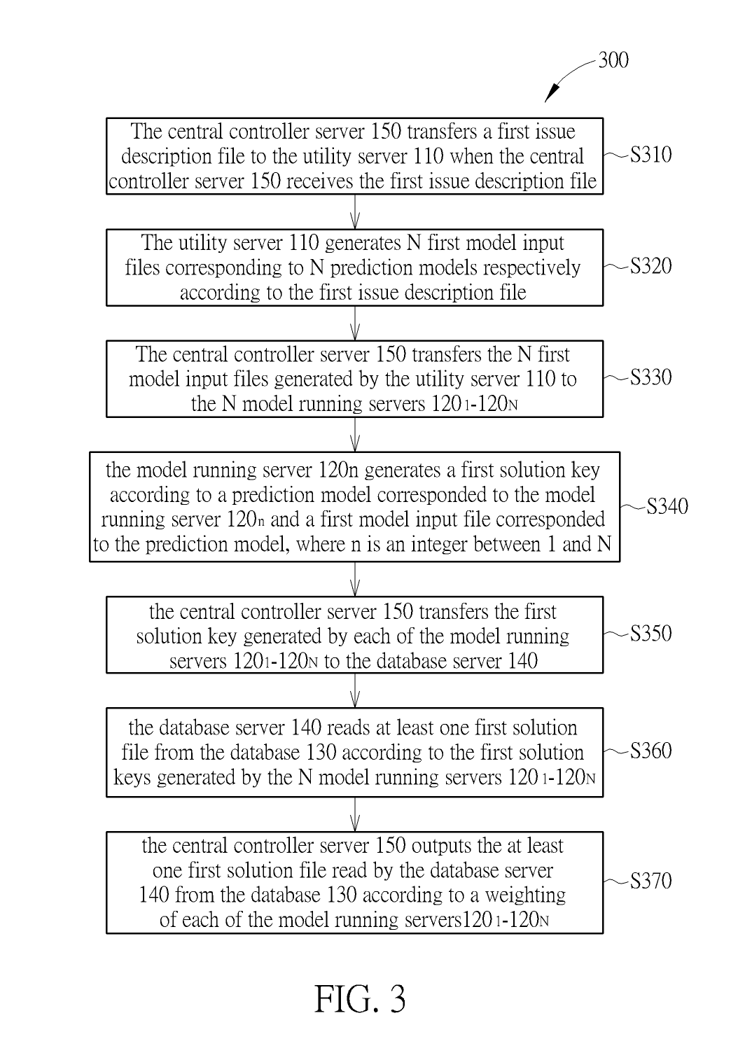

FIG. 3 shows a flowchart of a method 300 of operating the solution searching systems 100 and 200. The method 300 of operating the solution searching system includes steps S310 to S370:

S310: the central controller server 150 transfers a first issue description file to the utility server 110 when the central controller server 150 receives the first issue description file;

S320: the utility server 110 generates N first model input files corresponding to N prediction models respectively according to the first issue description file;

S330: the central controller server 150 transfers the N first model input files generated by the utility server 110 to the N model running servers 120₁-120_{N};

S340: the model running server 120ₙ generates a first solution key according to a prediction model corresponded to the model running server 120ₙ and a first model input file corresponded to the prediction model, where n is an integer between 1 and N;

S350: the central controller server 150 transfers the first solution key generated by each of the model running servers 120₁-120_{N} to the database server 140;

S360: the database server 140 reads at least one first solution file from the database 130 according to the first solution keys generated by the N model running servers 120₁-120_{N};

S370: the central controller server 150 outputs the at least one first solution file read by the database server 140 from the database 130 according to a weighting of each of the model running servers 120₁-120_{N}.

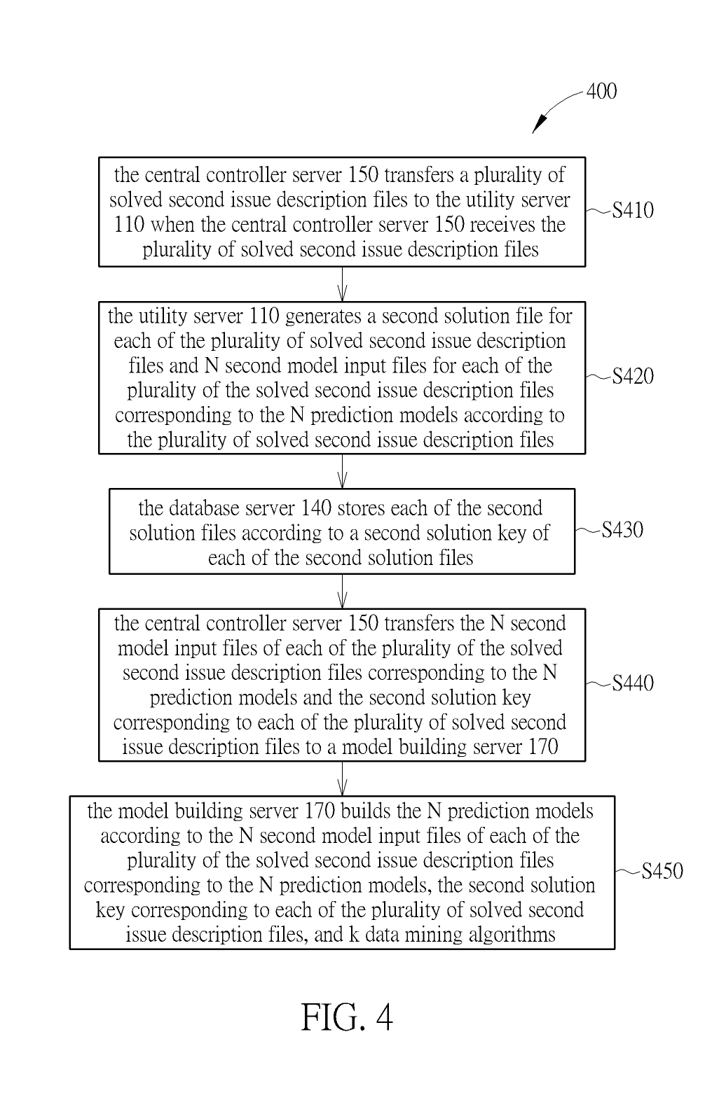

FIG. 4 shows a flowchart of a method 400 of operating the solution searching system 200. The method 400 of operating the solution searching system includes steps S410 to S450:

S410: the central controller server 150 transfers a plurality of solved second issue description files to the utility server 110 when the central controller server 150 receives the plurality of solved second issue description files;

S420: the utility server 110 generates a second solution file for each of the plurality of solved second issue description files and N second model input files for each of the plurality of the solved second issue description files corresponding to the N prediction models according to the plurality of solved second issue description files;

S430: the database server 140 stores each of the second solution files according to a second solution key of each of the second solution files;

S440: the central controller server 150 transfers the N second model input files of each of the plurality of the solved second issue description files corresponding to the N prediction models and the second solution key corresponding to each of the plurality of solved second issue description files to a model building server 170;

S450: the model building server 170 builds the N prediction models according to the N second model input files of each of the plurality of the solved second issue description files corresponding to the N prediction models, the second solution key corresponding to each of the plurality of solved second issue description files, and k data mining algorithms.

According to the embodiments of the present invention, the solution searching systems 100 and 200 and the methods 300 and 400 can help the engineers to share their experiences on how they solve the system issues before, search the possible solutions easily to save time, and can also improve the quality of the solutions by adopting the techniques of big data and data mining.

In summary, the solution searching system and the method of operating the solution searching system according to the embodiments of the present invention can adopt the database for big data and the data mining algorithms to help the users to share their experiences on how they solve the system issues before, and can help the users to search the possible solutions when the users encounter system issues. Consequently, the inefficiency of the searching system and the difficulty of controlling the quality of solution in the prior are can be solved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A solution searching system, comprising:
a utility server configured to generate N first model input files corresponding to N prediction models respectively according to a first issue description file, wherein N is an integer greater than 1;
N model running servers, each of the model running servers is corresponding to a weighting and a prediction model of the N prediction models, each of the model running servers is configured to generate a first solution key according to the prediction model corresponded to the model running server and a first model input file corresponded to the prediction model;
a database;
a database server configured to read at least one first solution file from the database according to the first solution keys generated by the N model running servers; and
a central controller server configured to:
transfer the first issue description file to the utility server when receiving the first issue description file;
transfer the N first model input files generated by the utility server to the N model running servers;
transfer the first solution key generated by each of the model running servers to the database server; and
output the at least one first solution file read by the database server from the database according to the weighting of each of the model running servers.

2. The solution searching system of claim 1, wherein the central controller server is further configured to:
transfer a plurality of solved second issue description files to the utility server to make the utility server generate a second solution file for each of the plurality of solved second issue description files and N second model input files for each of the plurality of the solved second issue description files corresponding to the N prediction models according to the plurality of solved second issue description files when receiving the plurality of solved second issue description files;
make the database server to store each of the second solution files according to a second solution key of each of the second solution files; and
transfer the N second model input files of each of the plurality of the solved second issue description files corresponding to the N prediction models and the second solution key of each of the plurality of solved second issue description files to a model building server to make the model building server build the N prediction models according to the N second model input files of each of the plurality of the solved second issue description files corresponding to the N prediction models and the second solution key corresponding to each of the plurality of solved second issue description files.

3. The solution searching system of claim 2, wherein the central controller server is further configured to:
transfer a plurality of testing issue description files to the utility server when receiving the plurality of testing issue description files;
transfer N testing model input files corresponding to each of the test issue description files generated by the utility server to the N model running servers;
transfer a test solution key corresponding to each of the test issue description files generated by each of the model running servers to the database server; and
set an initial value of the weighting for each of the model running servers according to whether the test solution key generated by each of the model running servers is correct or not.

4. The solution searching system of claim 2, wherein the central controller server is further configured to make the model building server rebuild the N prediction models when the central controller server receives a predetermined number of the first issue description files.

5. The solution searching system of claim 1, wherein the central controller server is further configured to:
generate an attribute description file according to words in the first issue description file; and
generate m predictor files according to the attribute description file;
wherein the utility server generates the N first model input files according to the first issue description file is generating the N first model input files according to the m predictor files and k data mining algorithms, m and k are positive integers.

6. The solution searching system of claim 5, wherein each of the first model input files is corresponding to a predictor file of the m predictor files and a data mining algorithm of the k data mining algorithm, and every two first model input files have different combinations of the predictor file and the data mining algorithm.

7. The solution searching system of claim 1, wherein the central controller server is further configured to adjust the weighting of each of the model running servers that generates the same first solution key as a solution key corresponding to a correct solution file, when the correct solution file of the at least one first solution file is selected.

8. A method of operating a solution searching system, wherein the solution searching system comprises a utility server, N model running servers, a database, a database server and a central controller server, the method comprising:
the central controller server transferring a first issue description file to the utility server when receiving the first issue description file;
the utility server generating N first model input files corresponding to N prediction models respectively according to the first issue description file, wherein N is an integer greater than 1;
the central controller server transferring the N first model input files generated by the utility server to the N model running servers;
each of the N model running servers generating a first solution key according to a prediction model corresponded to the model running server and a first model input file corresponded to the prediction model;
the central controller server transferring the first solution key generated by each of the model running servers to the database server;
the database server reading at least one first solution file from the database according to the first solution keys generated by the N model running servers; and
the central controller server outputting the at least one first solution file read by the database server from the database according to a weighting of each of the model running servers.

9. The method of claim 8, wherein solution searching system further comprises a model building server, the method further comprising:
the central controller server transferring a plurality of solved second issue description files to the utility server when the central controller server receives the plurality of solved second issue description files;
the utility server generating a second solution file for each of the plurality of solved second issue description files and N second model input files for each of the plurality of the solved second issue description files corresponding to the N prediction models according to the plurality of solved second issue description files;
the database server storing each of the second solution files according to a second solution key of each of the second solution files;
the central controller server transferring the N second model input files of each of the plurality of the solved second issue description files corresponding to the N prediction models and the second solution key corresponding to each of the plurality of solved second issue description files to a model building server; and
the model building server building the N prediction models according to the N second model input files of each of the plurality of the solved second issue description files corresponding to the N prediction models and the second solution key corresponding to each of the plurality of solved second issue description files.

10. The method of claim 9, further comprising:
the central controller server transferring a plurality of testing issue description files to the utility server when receiving the plurality of testing issue description files;
the central controller server transferring N testing model input files corresponding to each of the test issue description files generated by the utility server to the N model running servers;
the central controller server transferring a test solution key corresponding to each of the test issue description files generated by each of the model running servers to the database server; and
the central controller server setting an initial value for the weighting of each of the model running servers according to whether the test solution key generated by each of the model running servers is correct or not.

11. The method of claim 9, further comprising the central controller server making the model building server rebuild the N prediction models when the central controller server receives a predetermined number of the first issue description files.

12. The method of claim 8, wherein the utility server generating the N first model input files corresponding to the N prediction models respectively according to the first issue description file further comprises:
the utility server generating an attribute description file according to words in the first issue description file;
the utility server generating m predictor files according to the attribute description file; and
the utility server generating the N first model input files according to the m predictor files and k data mining algorithms, wherein m and k are positive integers.

13. The method of claim 12, wherein each of the first model input files is corresponding to a predictor file of the m predictor files and a data mining algorithm of the k data mining algorithm, and every two first model input files have different combinations of the predictor file and the data mining algorithm.

14. The method of claim 8, further comprising:
selecting a correct solution file of the at least one first solution file; and
the central controller server adjusting the weighting of each of the model running server that generates the same first solution key as a solution key corresponding to the correct solution file.
